(19) United States
(12) Patent Application Publication
(10) Pub. No.: US 2012/0324439 A1
(43) Pub. Date: Dec. 20, 2012

(54) CONFIGURATION INFORMATION MANAGEMENT METHOD AND CONFIGURATION INFORMATION MANAGEMENT DEVICE

(75) Inventors: Masatoshi KIMURA, Kawasaki (JP); Tetsukazu MOCHIZUKI, Kawasaki (JP); Rieko UTSUMI, Isehara (JP)

(73) Assignee: FUJITSU LIMITED, Kawasaki-shi (JP)

(21) Appl. No.: 13/462,678

(22) Filed: May 2, 2012

(30) Foreign Application Priority Data
Jun. 14, 2011 (JP) 2011-132518

(51) Int. Cl. G06F 9/445

(52) U.S. Cl. 717/175

(57) ABSTRACT

A configuration information management method includes: installing, by a computer, a first application based on an instruction for installation of the first application including first identification information; determining whether or not related identification information relating to the first identification information is stored in a first file for storing information of the first application in the installation; holding the related identification information stored in the first file when the related identification information is stored; and registering, in the first file, the first identification information as identification information for the first application when the related identification information is not stored.

### CROSS-REFERENCE TO RELATED APPLICATION(S)

This application is based upon and claims the benefit of priority of the prior Japanese Patent Application No. 2011-132518, filed on Jun. 14, 2011, the entire contents of which are incorporated herein by reference.

### FIELD

The embodiments discussed herein are related to a configuration information management method and a configuration information management device.

### BACKGROUND

An application maker may produce an application of a distribution version for download sales and an application of a pre-installation version that is to be preinstalled into personal computers. The name of the application of the distribution version may be different from the name of the application of the pre-installation version. For example, “basic name + for A company” may be adopted as the name of the application of the pre-installation version to be preinstalled into personal computers of the A company of a computer maker. A “basic name” may be adopted as the name of the application of the distribution version.

In regard to an application to be preinstalled into personal computers, a computer maker may provide support for handling of a failure or the like. The application of the distribution version may not be supported by a computer maker. In response to a request for the handling of the failure of an application which is made by a user, it is determined whether the application is a pre-installation version or a distribution version.

Related art is disclosed in Japanese Laid-open Patent Publication No. 2007-293737, Japanese Laid-open Patent Publication No. 9-179727, or the like.

### SUMMARY

According to one aspect of the embodiments, a configuration information management method includes: installing, by a computer, a first application based on an instruction for installation of the first application including first identification information; determining whether or not related identification information relating to the first identification information is stored in a first file for storing information of the first application in the installation; holding the related identification information stored in the first file when the related identification information is stored; and registering, in the first file, the first identification information as identification information for the first application when the related identification information is not stored.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary installer process;

FIG. 2 illustrates exemplary configuration information;

FIG. 3 illustrates exemplary information;

FIG. 4 illustrates exemplary information;

FIG. 5 illustrates an exemplary an uninstaller process;

FIG. 6 illustrates an exemplary flowchart of an uninstaller process;

FIG. 7 illustrates an exemplary flowchart of an uninstaller process;

FIG. 8 illustrates an exemplary computer;

FIG. 9 illustrates an exemplary flowchart of an installer process; and

FIG. 10 illustrates an exemplary flowchart of an uninstaller process.

### DESCRIPTION OF EMBODIMENTS

It may be determined whether this time's installation is available based on a presence or absence of an installation of a same type of a previous application. At the time of uninstallation, a file to be uninstalled may be determined based on a comparison result between current file information and file information before installation.

When an application is reinstalled, an application name may be rewritten. For example, an application of a distribution version may be installed into an installed application of a pre-installation version, and a name may be overwritten. When an application of an updated version is installed after an application has been uninstalled, the name of the distribution version may be registered.

When the name of a pre-installation version is overwritten with the name of a distribution version, the pre-installation version is determined to be a distribution version, and the pre-installation version may not receive the support of a computer maker.

Identification information includes information to be displayed in the name or title of an application and confirmed by a user.

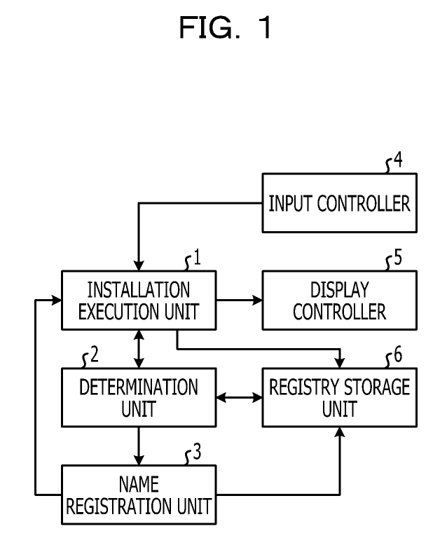

FIG. 1 illustrates an exemplary installer process of an installer. FIG. 1 illustrates a function unit generated on a computer when an installer including a configuration information management program is executed as a process in the computer.

An application to be installed and uninstalled may use a software access point.

When the installer including the configuration information management program is executed, the computer may include an installation execution unit 1, a determination unit 2, a registry storage unit 6, and a name registration unit 3.

The registry storage unit 6 may corresponds to a storage device such as a hard disk, a memory, or the like. The registry storage unit 6 stores therein a registry corresponding to a storage file storing therein the information of the basic configuration of an application, managed by an Operation System (OS). In the registry, a Globally Unique Identifier (GUID) serving as the identifier of the application is stored with being associated with the storage location of the information of the basic configuration of an application. The GUID is used as a unique identifier in the world with respect to each application. In any one of a distribution version and a pre-installation version, the same GUID is used if an application is the same.

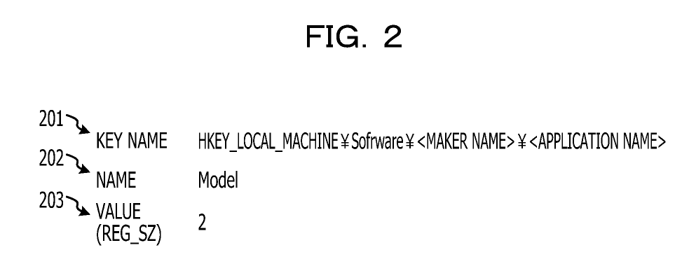

FIG. 2 illustrates exemplary configuration information. The configuration information illustrated in FIG. 2 may be stored in a registry.

The configuration information illustrated in FIG. 2 may be the configuration information of an icon used in response to the type of a device. A directory in which the configuration information is stored is described in a key name 201. The name of the configuration information is described in a name 202. For example, the name of the configuration information may be “Model”. The value of the configuration information is described in a value 203. For example, in the case of a desktop-type computer, “2” is described in the value 203, and in the case of a note-type computer, “1” is described in the value 203.

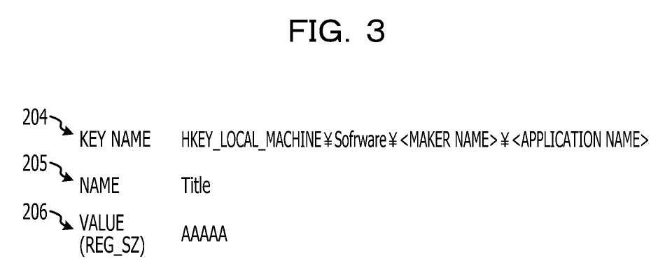

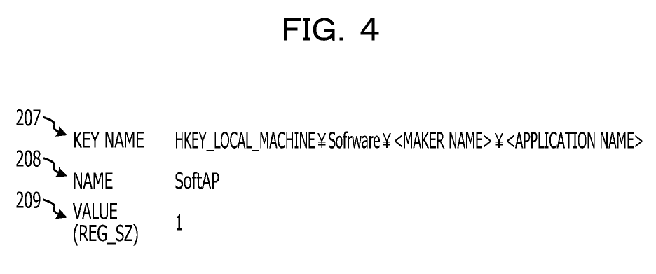

FIG. 3 illustrates an exemplary configuration information. The configuration information illustrated in FIG. 3 may be stored in a registry. The configuration information illustrated in FIG. 3 may be the information of the name of an application. A directory of a storage destination is described in a key name 204. “Title” indicating the configuration information of the name of an application is described in a name 205. The name of the application is described in a value 206. For example, in the case of a pre-installation version, “AAAAA” is described in the value 206. For example, in the case of the application of a distribution version developed for an OS “BBBBB”, “AAAAA for BBBBB” is described in the value 206. The information of the name of the application is stored in the registry, and the information of the name of the application to be stored in the registry is displayed as a title in accordance with the activation of the application. For example, when the OS is a Windows (registered trademark) system, the information of the name of the application may be displayed in the title bar of a window in which the application operates. Since an operator receiving support passes on the displayed title as the name of the application, the supporter of the application of a distribution version is notified of the name stored in the registry. For example, in a case in which the application includes a menu used for displaying product information or a version number, when the product information or the version number is displayer in response to the instruction of the menu from the operator, the name stored in the registry may be displayed. The name stored in the registry is transmitted from the operator to the supporter of the application of a distribution version. FIG. 4 illustrates an exemplary configuration information. The configuration information illustrated in FIG. 4 may be stored in a registry. The configuration information illustrated in FIG. 4 may be information relating to the use of a software access point. A directory of a storage destination is described in a key name 207. “SoftAP” indicating the configuration information relating to the use of a software access point is described in a name 208. Information (flag) indicating the validity or invalidity of the use of the software access point at the time of the operation of the application is described in a value 209. When the use of the software access point is selected, “1” indicating the validity of the use is described in the value 209. The application provides the operator with a function for utilizing the software access point. When the disuse of the software access point is selected, “0” indicating the invalidity of the use is described in the value 209. The application may not provide the operator with the function for utilizing the software access point.

Upon receiving, from the operator, an instruction for starting the installation of an application, the installation execution unit 1 starts installing the designated application.

The installation execution unit 1 determines whether or not the application to be installed has been already installed. When the application has been installed, the installation execution unit 1 instructs the display controller 5 to give notice of the message of that effect, and terminates the installation processing.

When the application has not been installed, the installation execution unit 1 determines whether or not the OS operating in a computer is compliant with the software access point. When the OS is compliant with the software access point, the installation execution unit 1 outputs, to the display controller 5, a request for displaying a question used for determining the validity or invalidity of the use of the software access point. The installation execution unit 1 receives, from the input controller 4, a response of the operator to the question that is used for determining the validity or invalidity of the use of the software access point and displayed in the display unit. In response to the response of the operator, the installation execution unit 1 determines the validity or invalidity of the use of the software access point and sets in a registry. According to the above-mentioned process, information relating to the validity or invalidity of the use of the software access point, illustrated in FIG. 4, may be set in a registry.

When the name of the application is registered in a registry in the installation, the installation execution unit 1 notifies the determination unit 2 of the execution of registering the name of the application, along with a GUID.

The installation execution unit 1 receives a notice of no change in the name of the application from the determination unit 2, or a notice of the completion of the registration of the name of the application from the name registration unit 3. The installation execution unit 1 continues the processing of the installation of the application, and completes the installation of the application.

The determination unit 2 receives, from the installation execution unit 1, the notice of the execution of registering the name of the application, along with the GUID of the application. The determination unit 2 searches within the registry storage unit 6 based on the received GUID, and identifies a location in which the information of the basic configuration of the application is to be stored. The determination unit 2 determines whether or not the information of the name of the application has been stored at the location in the registry, in which the information of the basic configuration of the application is to be stored. The location searched based on the GUID may correspond to the key names of the registries illustrated in FIG. 2, FIG. 3, and FIG. 4.

When there is no location in which the information of the basic configuration of the application is to be stored or when no information of the name of the application has been stored even if there is a location in which the information of the basic configuration is to be stored, the determination unit 2 notifies the name registration unit 3 of an instruction for the registration of the name of the application. The instruction for the registration of the name may include the information of a registry in which the name is to be registered, for example, a key name. The information of the registry may be used for registration relating to another item in the registry.

When the information of the name of the application has been stored, the determination unit 2 transmits, to the installation execution unit 1, a notice of no change in the name. For example, when the information of a pre-installation version, illustrated in FIG. 3, has been stored in the registry, the determination unit 2 holds the information, “AAAAA”, of the value 206 illustrated in FIG. 3. When the information, “AAAAA for BBBBB”, of a distribution version has been stored in the value of 206 in the registry, the determination unit holds the information, “AAAAA for BBBBB”, of the value 206.

The name registration unit 3 receives the instruction for registering the name of the application from the determination unit 2. The name registration unit 3 registers the name of the application in a registry included in the registry storage unit 6. For example, when, in the registry, there is no location for storing the information of the basic configuration of the application, the name registration unit 3 generates a storage location in response to the instruction from the determination unit 2, and registers the information of the name of the application. When, in the registry, there is a location for storing the information of the basic configuration of the application, the information of the name of the application is registered in the location.

For example, when there is no information of the name of the application in the registry and the information of a distribution version is written into the registry, the name registration unit 3 registers the information, “AAAAA for BBBBB”, of a distribution version in the value 206 illustrated in FIG. 3.

The name registration unit 3 transmits, to the installation execution unit 1, a notice of the completion of registering the name of the application in the registry.

The input controller 4 transmits, to the installation execution unit 1, the information of an instruction from the operator, input from the input unit such as a keyboard or the like. For example, upon receiving an answer from the operator to the question that is used for determining the validity or invalidity of the software access point and has been asked by the installation execution unit 1, the input controller 4 transmits the answer to the installation execution unit 1.

The display controller 5 displays a screen based on a display instruction in the display unit such as a monitor or the like. For example, based on an instruction from the installation execution unit 1, the display controller 5 displays, in the display unit, a message indicating that the application has been installed. Based on a display instruction from the installation execution unit 1, the display controller 5 displays, in the display unit, a screen for giving notice of the question used for determining the validity or invalidity of the software access point.

A configuration information management program may be incorporated in the uninstaller of the application after the application has been installed, and operate as a portion of the uninstaller at the time of uninstallation.

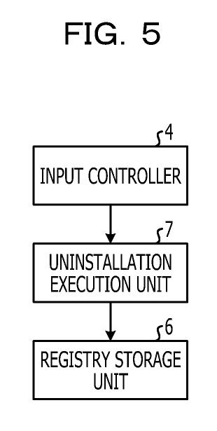

FIG. 5 illustrates an exemplary uninstaller process. FIG. 5 illustrates a function unit generated on a computer when the uninstaller including the configuration information management program is executed as a process in the computer.

When the uninstaller including the configuration information management program is executed, the computer includes an uninstallation execution unit 7, an input controller 4, and a registry storage unit 6.

Upon receiving, from the input controller 4, an instruction for uninstallation from the operator, the uninstallation execution unit 7 executes the uninstallation. In the execution of the uninstallation, the uninstallation execution unit 7 holds the information of the name of the application from among the information of the basic configuration of the application, stored in a registry, and deletes the other information of the basic configuration. The uninstallation execution unit 7 terminates the uninstallation after having executed other uninstallation process.

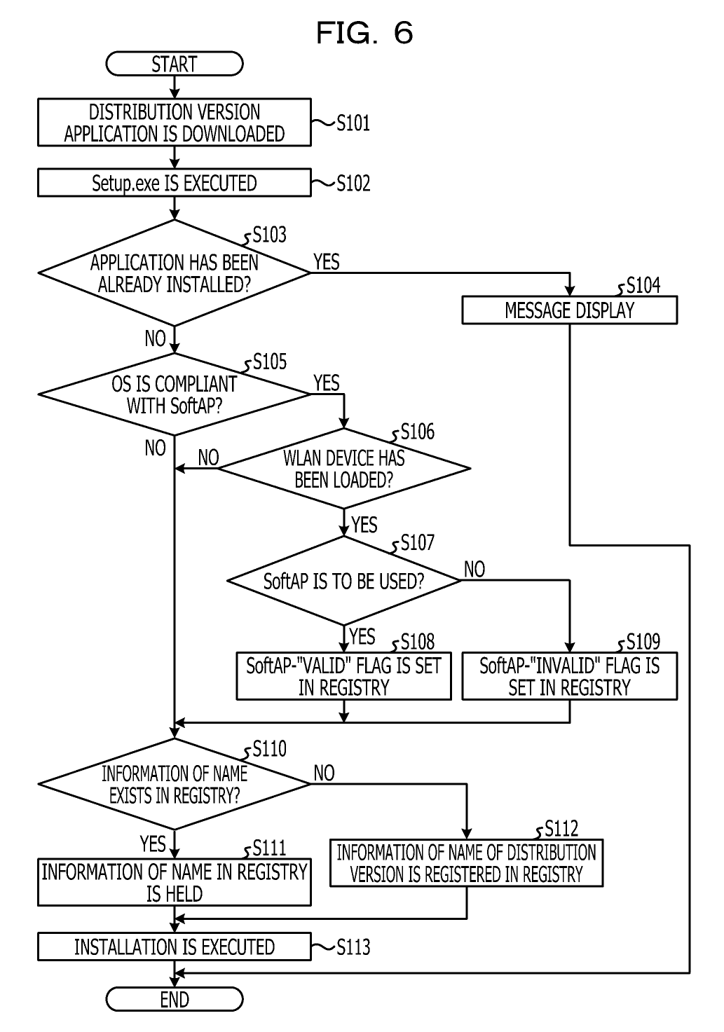

FIG. 6 illustrates an exemplary flowchart of an uninstaller process. A software access point provided in the OS, for example, SoftAP illustrated in FIG. 6, may be used, and a wireless LAN (WLAN: Wireless Local Area Network) may be used.

In an operation S101, the operator downloads the application of a distribution version from a server on a Web through a network. The download may be performed through a wireless LAN or a wired LAN. The application is decompressed as appropriate.

In an operation S102, the operator executes an installer (for example, defined as Setup.exe) included in the downloaded application, and starts installing the application.

In an Operation S103, the installation execution unit 1 determines whether or not the application to be installed has been already installed. When the application has been already installed (the operation S103: affirmative), the installation execution unit 1 causes the display controller 5 to display the message indicating that the application has been already installed in the display unit, in an operation S104, and terminates the installation process.

When the application has not been installed yet (the operation S103: negative), in an operation S105 the installation execution unit 1 determines whether or not the OS is compliant with a software access point, for example, the OS is equipped with the software access point. When the OS is not compliant with the software access point (the operation S105: negative), the process proceeds to an operation S110.

When the OS is compliant with the software access point (the operation S105: affirmative), in an operation S106 the installation execution unit 1 determines whether or not a WLAN device has been loaded into the computer. When the WLAN device has not been loaded (the operation S106: negative), the process proceeds to an operation S110.

When the WLAN device has been loaded (the operation S106: affirmative), in an operation S107 the installation execution unit 1 determines whether or not the software access point is to be used. For example, the installation execution unit 1 may ask the operator a question used for determining the use of the software access point and, in response to a response from the operator, may determine whether or not the software access point is to be used. When the software access point is to be used (the operation S107: affirmative), in an operation S108 the installation execution unit 1 sets, in a registry, a flag validating the use of the software access point.

When the software access point is not to be used (the operation S107: negative), in an operation S109 the installation execution unit 1 sets, in a registry, a flag invalidating the use of the software access point.

The installation execution unit 1 instructs the determination unit 2 to determine whether or not the name of the application to be installed exists in a registry. In an operation S110, the determination unit 2 determines whether or not the information of the name of the application to be installed has been stored in a registry. When the information of the name of the application has been stored in the registry (the operation S110: affirmative), in an operation S111 the installation execution unit 1 receives a notice of the existence of the information of the name from the determination unit 2 and holds the information of the name in the registry.

When the information of the name of the application has not been stored in a registry (the operation S110: negative), in an operation S112 the name registration unit 3 receives an instruction for name registration from the determination unit 2, and registers the information of the name of the application of a distribution version in a registry.

In an operation S113, the installation execution unit 1 executes the installation of the application of a distribution version. For example, the application includes a plurality of program modules, an information file referenced and/or updated at the time of program module process, or the like. A program module or an information file may be copied into a preliminarily set directory or a directory designated by the operator at the time of the installation.

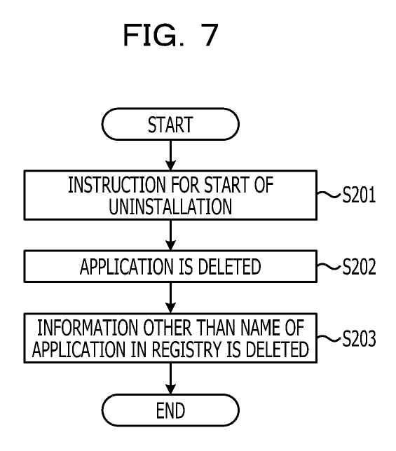

FIG. 7 illustrates an exemplary flowchart of an uninstaller process.

In an operation S201, the operator instructs the computer to start the uninstallation of the application. The uninstallation execution unit 7 executes the uninstallation.

In an operation S202, the uninstallation execution unit 7 deletes the application. The uninstallation execution unit 7 deletes, from the computer, a program module, which includes the application copied in the execution of the installation, or an information file.

In an operation S203, the uninstallation execution unit 7 deletes, from a registry, information relating to an application other than a name stored in the registry with holding the name of the application to be stored in the registry.

When the information of the name of the application has been stored in the registry at the time of installation, the configuration information management program uses the name stored in the registry. When the name of the application has not been stored in the registry at the time of installation, the name of the application to be installed is registered in the registry. At the time of uninstallation, the name of the application stored in the registry is held in the registry without being deleted.

The application of a pre-installation version may be called a “pre-installation version”. The application of a distribution version may be called a “distribution version”. For example, after having uninstalled an installed pre-installation version, the operator may install a distribution version.

When the operator executes the uninstallation of the pre-installation version, the configuration information management program may use the information of the name of the pre-installation version stored in a registry. Therefore, after uninstallation, the information of the name of the pre-installation version is maintained in the registry.

In a state in which the information of the name of the pre-installation version has been stored, the operator installs the distribution version. Since the information of the name of the pre-installation version has been stored in the registry, the configuration information management program completes the installation with maintaining the name of the pre-installation version stored in the registry.

After the pre-installation version has been deleted and the distribution version has been installed, the name of the pre-installation version has been stored in the registry, as the information of the name of the application. Therefore, when the application is executed, the name of the pre-installation version may be displayed as the name of the application. When, at the time of the occurrence of a failure, querying the provider of the application, for example, a computer maker providing the computer into which the application is pre-installed, the operator may pass on the name of the pre-installation version to the provider.

The configuration information management program holds an application name installed first. In a computer into which the application of a pre-installation version has been installed, the name of the pre-installation version continues to be displayed as the name of the application. When the application of a distribution version has been installed into a computer into which the application of a pre-installation version has not been installed, the name of the distribution version may be displayed as the name of the application.

Since it is determined whether an initial application has been a pre-installation version or a distribution version based on a name, it is determined whether an application is the target of support based on the name. The provider of the application may provide a swift response at the time of a response to a failure.

The installer including the configuration information management program may come with the application of a distribution version. For example, the application of a distribution version may be distributed using a recording medium such as a Digital Versatile Disc (DVD), a Compact Disk (CD), or the like. The application of a distribution version may be downloaded from a computer located on a network such as Internet or the like, using a Wireless Local Area Network (WAN), a Local Area Network (LAN), or the like.

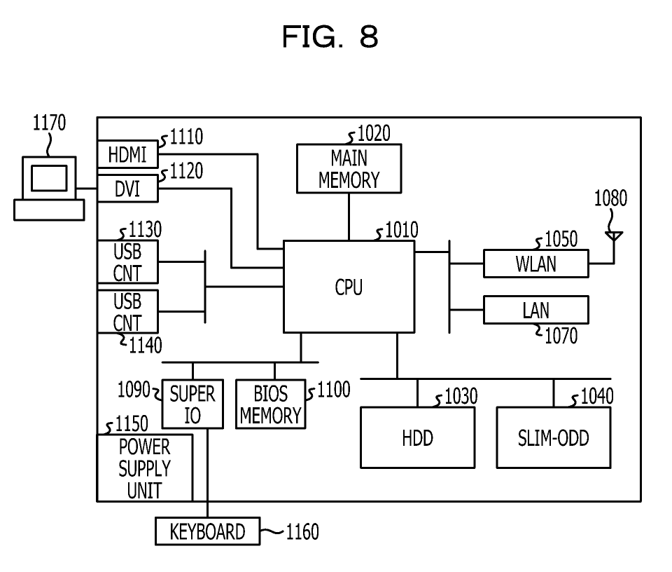

FIG. 8 illustrates an exemplary computer.

The computer illustrated in FIG. 8 includes a Central Processing Unit (CPU) 1010, a Main Memory 1020, a Hard Disk Drive (HDD) 1030, and a Slim-Optical Disk Drive (ODD) 1040. The computer includes a WLAN 1050, a LAN 1070, an antenna 1080, and a Super Input/Output (IO) 1090. The computer includes a Basic Input/Output System (BIOS) memory 1100, a High Definition Multimedia Interface (HDMI) 1110, and a Digital Visual Interface (DVI) 1120. The computer includes a Universal Serial Bus Controller (USBCNT) 1130, a USBCNT 1140, a Power Supply Unit 1150, a keyboard 1160, and a monitor 1170.

The CPU 1010 may be the main processing circuit of the computer. The Main Memory 1020 and the HDD 1030 are coupled to the CPU 1010 through a bus. The Slim-ODD 1040, the WLAN 1050, the LAN 1070, the Super IO 1090, the BIOS 1100, the HDMI 1110, the DVI 1120, the USBCNT 1130, and the USBCNT 1140 are coupled to the CPU 1010 through a bus. The WLAN 1050 is coupled to the antenna 1080. The DVI 1120 is coupled to the monitor 1170. The monitor 1170 may be coupled to the HDMI 1110. The keyboard 1160 is coupled to the Super IO 1090. The Power Supply Unit 1150 supplies power to individual units other than the monitor 1170. In FIG. 8, a wiring line for supplying power from the Power Supply Unit 1150 to individual units may be omitted.

The WLAN 1050 transmits and receives data to and from the outside through the antenna 1080 using wireless communication. The LAN 1070 is coupled to a network, and transmits and receives data to and from the outside. The application of a distribution version, update data, and the like may be downloaded through the WLAN 1050 or the LAN 1070, for example.

The Slim-ODD 1040 may be a DVD drive. When the application of a distribution version, update data, and the like are distributed using a DVD, the Slim-ODD 1040 may acquire the application of a distribution version, the update data, and the like from the DVD, for example.

The BIOS memory 1100 may be a nonvolatile storage device that stores therein a program group, for example, a BIOS, the program group controlling a disk drive, a keyboard, a video card, or the like, coupled to the computer.

The USBCNTs 1130 and 1140 may be control circuits for USB devices coupled to the USB connectors of the computer.

For example, the CPU 1010, the HDMI 1110, and the monitor 1170 may include the function of the display controller 5 illustrated in FIG. 1. For example, the CPU 1010, the Super IO 1090, and the keyboard 1160 may include the function of the input controller 4 illustrated in FIG. 1.

For example, the HDD 1030 may include the function of the registry storage unit 6. An OS, an installed application, an uninstaller, a registry, and the like may be stored in the HDD 1030.

For example, the CPU 1010, the Main Memory 1020, and the HDD 1030 may include the functions of the installation execution unit 1, the determination unit 2, and the name registration unit 3, illustrated in FIG. 1, and the function of the uninstallation execution unit 7 illustrated in FIG. 5 or the like. For example, when an installer is downloaded through a network using the WLAN 1050 or the LAN 1070, the HDD 1030 stores therein the downloaded installer. The CPU 1010 reads and loads an installer stored in the HDD 1030, into the Main Memory 1020, and executes the installer. A process executing the functions of the installation execution unit 1, the determination unit 2, and the name registration unit 3 may be generated. The CPU 1010 reads and loads an uninstaller stored in the HDD 1030, into the Main Memory 1020, and executes the uninstaller. A process executing the function of the uninstallation execution unit 7 may be generated.

At the time of installation, the configuration information management program maintains the configuration information of another application providing substantially the same function as or a function similar to the function of the application to be installed. A function unit generated on the computer is illustrated in FIG. 1 when the installer including the configuration information management program is executed as a process in the computer. A function unit generated on the computer is illustrated in FIG. 5 when the uninstaller including the configuration information management program is executed as a process in the computer. For example, as the other application providing substantially the same function as or a function similar to the function of the application to be installed, a wireless network application (hereinafter, simply referred to as a wireless network utilization application) utilizing a software access point may be used.

The installation execution unit 1 illustrated in FIG. 1 may preliminarily memorize that the wireless network utilization application is an application including substantially the same function as or a function similar to the function of the application to be installed. For example, in an installation program generating the function of the installation execution unit 1, the wireless network utilization application is preliminarily designated as an application providing substantially the same function as or a function similar to the function of the application to be installed.

The installation execution unit 1 determines whether or not the OS of the computer is compliant with the software access point. When the OS is compliant with the software access point, the installation execution unit 1 instructs the determination unit 2 to determine whether or not the configuration information of the wireless network utilization application has been stored in a registry. The installation execution unit 1 outputs the GUID of the wireless network utilization application to the determination unit 2. When the configuration information of the wireless network utilization application has been stored in a registry, the installation execution unit 1 sets the use of the software access point to validity at the time of the operation of the application to be installed, based on the configuration information of the wireless network utilization application stored in the registry.

When the configuration information of the wireless network utilization application has not been stored in the registry, a request for displaying a question used for determining the validity or invalidity of the use of the software access point is supplied to the display controller 5. The installation execution unit 1 receives, from the input controller 4, an input of a response of the operator to the question that is used for determining the validity or invalidity of the use of the software access point and displayed in the display unit. In response to the response of the operator, the installation execution unit 1 determines and sets the validity or invalidity of the use of the software access point in the registry storage unit 6.

When an application name is registered at the time of the process of installation, the installation execution unit 1 notifies the determination unit 2 of the execution of registering the name of the application, along the GUID of the application. The installation execution unit 1 receives a notice of no change in the name of the application from the determination unit 2 or a notice of the completion of the registration of the name of the application from the name registration unit 3. The installation execution unit 1 continues the installation of the application, and completes the installation of the application. In the installation of the application, a program module or an information file, included in the application, is copied into the computer.

Along with the GUID, the determination unit 2 receives, from the installation execution unit 1, an instruction for determining whether or not the configuration information of the wireless network utilization application has been stored in the registry. Based on the GUID, the determination unit 2 searches a location in the registry storage unit 6, in which the configuration information of the wireless network utilization application has been stored, and determines whether or not the configuration information has been stored. The determination unit 2 outputs, to the installation execution unit 1, a determination result indicating whether or not the configuration information of the wireless network utilization application has been stored in the registry.

The determination unit 2 receives, from the installation execution unit 1, the notice of the execution of the registration of the name of the application, along with the GUID of the application. Based on the received GUID, the determination unit 2 searches within the registry storage unit 6, and identifies a location in which the information of the basic configuration of the application has been stored. The determination unit 2 determines whether or not the information of the name of the application has been stored in the location within the registry, in which the information of the basic configuration of the application has been stored.

When there is no location in which the information of the basic configuration of the application has been stored or when no information of the name of the application has been stored even if there is a location in which the information of the basic configuration has been stored, the determination unit 2 notifies the name registration unit 3 of an instruction for the registration of the name of the application.

When the information of the name of the application has been stored, the determination unit 2 transmits, to the installation execution unit 1, a notice of no change in the name.

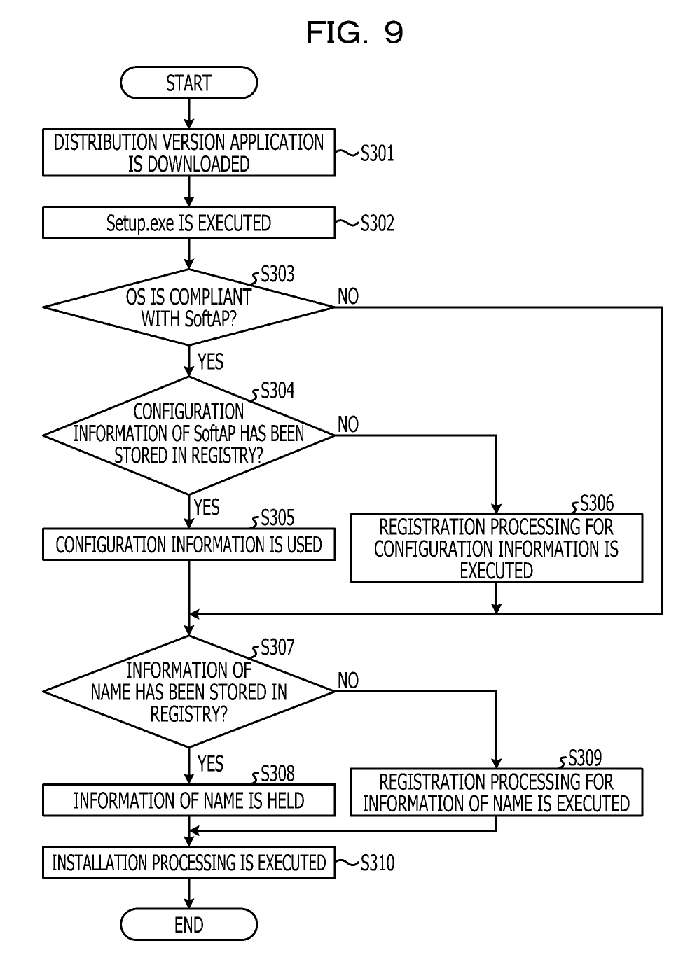

FIG. 9 illustrates an exemplary flowchart of an installer process. The process of an installer including a configuration information management program may be executed.

In an operation S301, the operator downloads the application of a distribution version from a server on a Web through a network.

In an operation S302, the operator executes an installer included in the downloaded application, for example, Setup.exe. The installer is activated, and installation is started.

In an operation S303, the installation execution unit 1 determines whether or not the OS is compliant with a software access point. When the installation execution unit 1 has determined that the OS is not compliant with the software access point (the operation S303: negative), the process proceeds to an operation S307.

When the OS is compliant with the software access point (the operation S303: affirmative), in an operation S304 the determination unit 2 determines whether or not configuration information for using the software access point has been stored in a registry. For example, the configuration information relating to the software access point may include a flag validating the use of the software access point of the present application, for example, the configuration information of the wireless network utilization application. When the flag validating the use of the software access point of the present application has been set or the configuration information of the wireless network utilization application has been stored (the operation S304: affirmative), the installation execution unit 1 perform setting for using the software access point at the time of the operation of the application. For example, in an operation S305, the flag validating the use of the software access point in the present application is set in a registry. When the flag validating the use of the software access point of the present application has been set in a registry before installation, the flag may be maintained with no change.

When the configuration information of the wireless network utilization application has not been stored (the operation S304: negative), the operations S107, S108, and S109 illustrated in FIG. 6 are executed. For example, the installation execution unit 1 asks the operator a question used for determining the use of the software access point and, in response to a response from the operator, determines whether or not the software access point is to be used. When the operator has selected the use of the software access point, the installation execution unit 1 sets, in a registry, a flag validating the use of the software access point. When the operator has selected the nonuse of the software access point, the installation execution unit 1 sets, in a registry, a flag invalidating the use of the software access point, in an operation S306.

In the operation S307, the determination unit 2 determines whether or not the information of the name of the application to be installed has been stored in a registry. When the information of the name of the application has been stored (the operation S307: affirmative), the installation execution unit 1 holds the information of the name of the application (an operation S308).

When the information of the name of the application has not been stored (the operation S307: negative), the name registration unit 3 executes registration process for the information of the name of the application (an operation S309).

In an operation S310, the installation execution unit 1 executes the other process at the time of the installation of the application, and completes the installation.

The uninstallation execution unit 7 preliminarily stores configuration information to be left at the time of uninstallation. For example, the uninstallation execution unit 7 stores configuration information which is used when an application to be uninstalled is installed again. For example, in an uninstallation program generating the function of the uninstallation execution unit 7, the information of the name of the application or a flag for setting the validity or invalidity of the use of the software access point may be preliminarily designated.

The uninstallation execution unit 7 searches within the registry storage unit 6 in the execution of uninstallation, and confirms whether configuration information to be preliminarily designated has been stored in a registry.

When the configuration information to be preliminarily designated has been stored in a registry, the uninstallation execution unit 7 holds the configuration information.

The uninstallation execution unit 7 confirms whether the information of the name of the application to be uninstalled has been stored in a registry.

When the information of the name of the application to be uninstalled has been stored in a registry, the uninstallation execution unit 7 holds the information of the name of the application to be uninstalled and regards the name of the application to be exempt from deletion. The uninstallation execution unit 7 confirms whether information for setting the validity or invalidity of the use of the software access point in the application to be uninstalled has been stored. When the information for setting the validity or invalidity of the use of the software access point has been stored in a registry, the uninstallation execution unit 7 holds the information without deleting the information. The uninstallation execution unit 7 deletes, from the registry, information relating to the application, other than the name of the application to be uninstalled and the information for setting the validity or invalidity of the use of the software access point. The uninstallation is executed with the configuration information of the software access point being held.

The uninstallation execution unit 7 executes the uninstallation with leaving the name of the application to be uninstalled and the configuration information of the software access point in the registry. After the uninstallation, the name of the application to be uninstalled and the configuration information relating to the use of the software access point have also been stored in the registry.

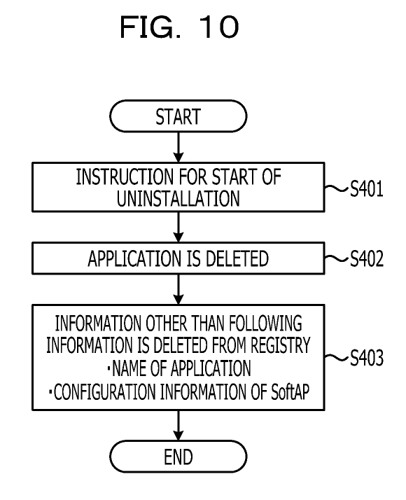

FIG. 10 illustrates an exemplary flowchart of an uninstaller process. The process of the uninstaller including the configuration information management program may be executed.

In an operation S401, the operator instructs the computer to start the uninstallation of the application. The uninstallation execution unit 7 executes the uninstallation.

In an operation S402, the uninstallation execution unit 7 deletes the application. A program module or an information file, included in the application copied in the execution of the installation, is deleted from the computer by the deletion of the application.

In an operation S403, the uninstallation execution unit 7 deletes information relating to the application, other than a name stored in the registry with holding the name of the application and the configuration information for the validity or invalidity of the use of the software access point, stored in the registry.

At the time of the installation of the application, the configuration information management program uses the configuration information of another application providing substantially the same function as or a function similar to the function of the application. The configuration information management program executes the uninstallation with holding, in the registry, the configuration information for setting the validity or invalidity of use at the time of the reinstallation of the application. Therefore, since the configuration information management program reuses the configuration information, a question and response process for the operator or the setting performed by the operator at the time of installation may be omitted. Therefore, the process load of the installation may be reduced.

The name of an application or other configuration information may be registered in a registry, for example, a storage file in which the information of the basic configuration of the application managed by the OS is stored, and the above-mentioned process may be executed at the time of the installation and/or at the time of the uninstallation of the application. Independently from the registry, a file may be used in which the application stores the configuration information thereof. The file may be held at the time of the uninstallation of the application, and the held file may be used at the time of the reinstallation thereof. The file may be stored in the directory of a system or a directory preliminarily defined as the installation destination of the application, and the storage location may be identified at the time of the reinstallation thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A configuration information management method comprising:
installing, by a computer, a first application based on an instruction for installation of the first application including first identification information;
determining whether or not related identification information relating to the first identification information is stored in a first file for storing information of the first application in the installation;
holding the related identification information stored in the first file when the related identification information is stored; and
registering, in the first file, the first identification information as identification information for the first application when the related identification information is not stored.

2. The configuration information management method according to claim 1, further comprising,
uninstalling the first application based on an instruction for uninstallation of the first application with holding the first identification information stored in the first file.

3. The configuration information management method according to claim 2, further comprising,
deleting basic configuration information other than the first identification information in the uninstallation.

4. The configuration information management method according to claim 1, further comprising,
using configuration information of a second application providing a function relating to a function of the first application, which is stored in one of the first file and a second file, in the installation.

5. The configuration information management method according to claim 1, wherein
the first identification information is a name of the first application.

6. The configuration information management method according to claim 4, wherein
a different name is set in the first application based on a difference in a distribution method of the first application.

7. The configuration information management method according to claim 4, wherein
the configuration information includes information indicating validity or invalidity of use of a software access point.

8. A configuration information management device comprising:
an execution unit to install a first application based on an instruction for installation of the first application including first identification information;
a determination unit to determine whether or not related identification information relating to the first identification information is stored in a first file for storing information of the first application in the installation; and
an identification information registration unit to hold the related identification information stored in the first file when the related identification information is stored and to register, in the first file, the first identification information as identification information for the first application when the related identification information is not stored.

9. The configuration information management device according to claim 8, further comprising:
an uninstallation execution unit to hold the first identification information stored in the first file and uninstall the first application based on an instruction for uninstallation of the first application.

10. The configuration information management device according to claim 8, wherein the execution unit uses configuration information of a second application providing a function relating to a function of the first application, which is stored in one of the first file and a second file, in the installation.
